(19) United States
(12) Patent Application Publication
(10) Pub. No.: US 2026/0037752 A1
(43) Pub. Date: Feb. 5, 2026

(54) Personal Motivation Analysis and Matching System Based on Large Language Models and Motivation DNA System

(71) Applicant: Equalearning Inc., San Diego, CA (US)

(72) Inventor: Shih-Yuan Wang

(21) Appl. No.: 19/293,298

(22) Filed: Aug. 7, 2025

Related U.S. Application Data
(63) Continuation-in-part of application No. 18/789,068, filed on Jul. 30, 2024.

(51) Int. Cl. G06F 40/40; G06F 40/205

(52) U.S. Cl. CPC G06F 40/40; G06F 40/205

(57) ABSTRACT

A method for a web platform trains a large language model platform (LLM) to select a special LLM and also generates a user profile based on a simple user input through this selected special LLM.

### CROSS REFERENCE TO RELATED APPLICATION

This application is a continuation-in-part of U.S. patent application Ser. No. 18/789,068, filed on Jul. 30, 2024, for Training Large Language Model To Analyze Psychological Test Data, the specification of which is incorporated herein by this reference.

### FIELD OF THE INVENTION

The present invention generally relates to computer-assist psychological testing system, and more specifically to an artificial intelligence based system and method for interpreting free form user input.

### BACKGROUND OF THE INVENTION

With the rapid development of Generative Artificial Intelligence (AI), many tools have emerged that utilize these technologies. However, in psychology, especially in the field of motivation science, no one has attempted to use Large Language Models (such as ChatGPT) for intrinsic motivation analysis and matching. Existing tools mainly focus on collecting and integrating external information but lack a deep understanding of individual intrinsic motivations.

One reason that makes difficult for existing tools to understand individual intrinsic motivations is the difficulty for the existing tools to devise a user input system and to interpret the user inputs.

### SUMMARY OF THE INVENTION

The present invention has been made to take advantage of advancement in AI and apply this advancement to the field of psychology or personality testing. The present invention is a cloud-based big data and AI platform capable of generating a user profile (MQ profile) based on a simple user description.

The present invention in one embodiment is a method for capturing a user input and generating a motivational quotient report comprises receiving the user input, parsing the user input to identify key motivational factors, selecting a special context-based large language model (LLM) engine based on the key motivational factors, the special context-based LLM engine assigning intensity levels to the key motivational factors, and the special context-based LLM engine generating a user profile with the key motivational factors, wherein the special context-based LLM engine is derived from a generic LLM engine that is trained with special models with motivational factors.

### BRIEF DESCRIPTION OF THE DRAWINGS

FIG. 1 is a diagram 100 of a system according to the present invention.

FIG. 2 is a process 200 describing a process according to the present invention.

FIG. 3 is a schematic 300 illustrating training of a specialized LLM engine.

FIG. 4 is a process 400 for generating individualized reports.

FIG. 5 illustrates an exemplary architecture 500 for a Motivation DNA engine 502 of the present invention.

### DETAIL DESCRIPTION OF THE INVENTION

The objective of this invention is to provide an intelligent platform based on Large Language Models capable of analyzing user or third-party descriptions of specific individuals and converting them into specific Motivation DNA factors and their intensity, ultimately finding suitable individuals in the Motivation DNA system's database. The Motivation DNA factors are factors that describe personal traits related to motivation, ambition, and drives. The platform analyzes verbal or textual descriptions to derive a set of motivational quotient (MQ) values for the suitable individuals and this allows a precise analysis of intrinsic motivations without requiring direct testing, ensuring flexibility and deeper insights into the individual's motivational profile.

The Motivation DNA factors can be better explained by examples in the table below.

TABLE 1

| | Motivation DNA | |
|---|---|---|
| Natural Language Description | Factor(s) | Explanation |
| She is highly creative and detail- | Creativity/ | Reflects both creativity and attention |
| focused. | Administrative Order | to detail/structure. |
| He enjoys working with people and | Team working/ | Indicates motivation for teamwork and |
| delivering results under pressure. | Expedience | efficiency under pressure. |
| He always helps others without | Altruism/Prestige | Shows motivation to help others and |
| seeking credit. | | desire for recognition/status. |
| She dislikes ambiguity and prefers | Administrative | Prefers order/structure and a stable, |
| structure. | Order/Serenity | stress-free environment. |
| Loves exploring new topics, asks | Inquisitive Curiosity | Motivated by seeking new knowledge |
| ‘why’ a lot. | | and understanding. |

This invention leverages the structural advantages of the Motivation DNA system, combined with the natural language understanding capabilities of Large Language Models (LLMs), to analyze user descriptions and identify user intentions and motivations. The result from the analysis may be used for different purposes. For example, a tool according to the present invention may be used to identify suitable individuals in a large database who fulfill the qualities described in common English or other languages by a user. This system significantly improves the accuracy and efficiency of human pairing, talent recruitment, and psychological analysis.

The system of the present invention provides two primary modes of operation. First, it can match individuals who have taken the MQ assessment by comparing their MQ profiles to input criteria, significantly improving the accuracy and efficiency of career development, and psychological consultation. For example, a recruiter can search the database for candidates with ‘high leadership potential’ or ‘collaborative team skills’ based on MQ scores and motivation DNA.

Secondly, the system introduces a reverse-inference capability for individuals who have not completed the MQ assessment. Through verbal or textual descriptions—such as ‘innovative thinker with strong attention to detail’—the system can generate an inferred MQ profile, quantifying the likely motivations and behavioral tendencies of the described person. This feature provides flexibility by enabling accurate motivational analysis even when formal assessments are unavailable.

Together, these capabilities allow the system to support a wide range of applications. For example, it enables recruiters to identify hidden talent, educators to create personalized learning strategies, and managers to align individuals with roles or teams based on inferred or assessed motivation profiles. This dual approach ensures comprehensive support for talent management, team formation, coaching, and psychological consultation.

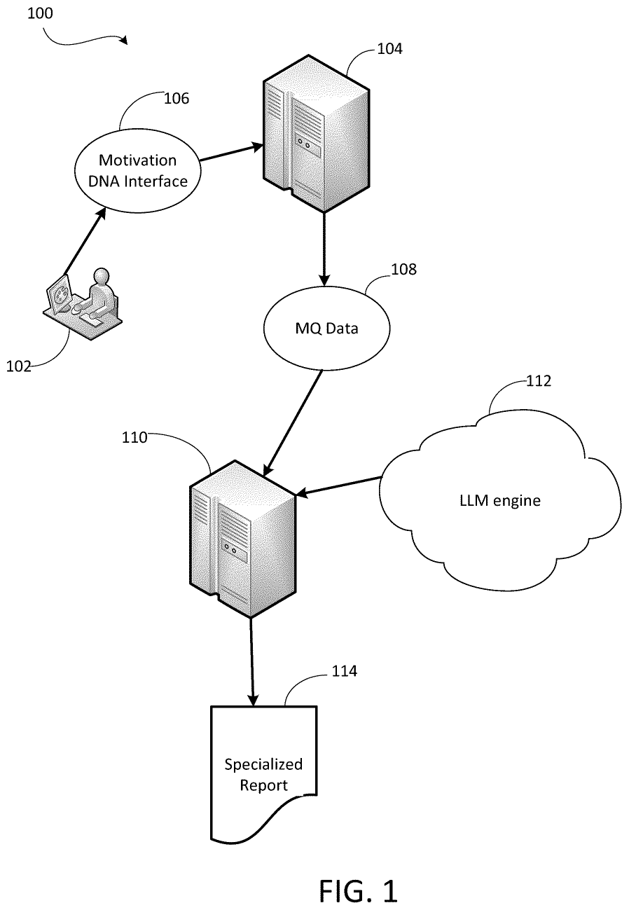

FIG. 1 is a diagram 100 illustrating implementation and use of the current invention. A user 102 may describe, either orally or in writing or uploading a document like performance review, the quality of an executive needed for a particular position in a company. This description through a user interface 106 is captured and sent to a server 104. The interface 106 may be located in the server 104 or on the user device. The description is processed by a motivation DNA engine that runs on the server 104. The motivation DNA engine analyzes the captured description considering many factors, such as the structure of the description and use of vocabulary. When the description is from a verbal input, the intonation and speech pace may also be considered. If the user is known, then user information, such as his education level, technical knowledge, and professional experience, will also be considered. The result from the analysis of the motivation DNA engine is a set of Motivation DNA factors similar to those illustrated in Table 1 above. The purpose of the analysis is to understand the motivation and intend of the user and derive an input set that can be used with the motivational engine described in the parent application Ser. No. 18/789,068 ('068 app), filed on Jul. 30, 2024.

The Motivation DNA engine will produce a set of MQ data 108 based on the capture description. This set of MQ data 108 is fed into a large language model (LLM) engine 112 that runs on a server 110 and the LLM engine 112 will produce a specialized report 114. The LLM engine 112 may also run on the server 104. This process described in FIG. 1 enables the LLM engine 112 to produce a specialized report 114 without requiring the user 102 to go through a MQ test engine described in the parent application ('068 app).

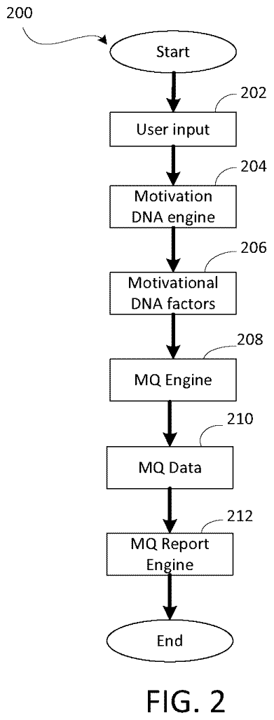

The system according to the present invention receives descriptions from users or third parties about a specific individual or a desired individual in the database. FIG. 2 is a process 200 describing the process according to the present invention. According to the process 200, the user enters a set of inputs or descriptions, step 202, that may include personality traits, behaviors, skill tendencies, etc. The system uses Large Language Models (such as ChatGPT) to parse these inputs/descriptions and identify key motivation-related descriptions.

The parsed descriptions are mapped to corresponding engines in the Motivation DNA system (e.g., humility corresponding to influence, strong appreciation for beauty corresponding to beauty, efficiency corresponding to expedience), step 204, and the intensity of each factor is determined. The corresponding engines convert these descriptions into Motivation DNA parameters, step 206, based on the pre-defined rules of the Motivation DNA system, such as mapping “humility” to “influence,” “artistic sensitivity” to “beauty,” and “efficiency” to “expedience,” assigning appropriate intensity values.

The pre-defined rules are contexts that can be understood by a large language model, such as MQ Engine, step 208. In essence, the MQ Engine converts knowledge of MQ data into contexts that train the large language model to learn how to identify corresponding Motivation DNA factors and assign intensity based on user inputs.

The MQ Engine compares the mapped Motivation DNA parameters, step 210, and their intensity with the large database in the Motivation DNA system. Based on the matching results, the system generates a report for individual who meet the described criteria, potentially best fitting the user or third party's needs, step 212. Users can make further selections or decisions based on the list of individuals provided by the system. Additionally, this system can be applied to human pairing, talent recruitment, team formation, personalized psychological consultation, and other fields to help users find the most suitable individuals.

The present invention elaborates on how to integrate Large Language Models with the Motivation DNA system for personal motivation analysis and matching. The system accurately parses user descriptions and leverages the structural advantages of the Motivation DNA system to provide high-precision personal motivation analysis results. This invention is particularly applicable to human pairing, talent recruitment, and psychological consultation, significantly enhancing the efficiency and accuracy of these fields.

The process of the present invention described above can be further explained below. The present invention employs a 5-step process to convert a free-form natural language input into a structured MQ profile using LLMs, RAG-based knowledge injection, and rule-based intensity evaluation.

On step 1: Natural Language Input with Prompts. The system provides prompt guidance to the user, including sample sentences or even an email history or chat log to describe a person. Example: ‘She is highly creative and detail-focused.’

On step 2: Semantic Parsing & Modifier Extraction. The LLM semantically parses the input and extracts key traits, along with all associated modifiers—such as adjectives, adverbs, and emotional tones—that influence intensity perception.

On step 3: MQ DNA Mapping via RAG-Based Context Learning. Part A—using retrieval-augmented generation (RAG), the LLM is trained on official MQ DNA definitions; Part B—additional examples are retrieved that match natural language patterns to the correct DNA labels. This enables the model to learn how descriptive language aligns with Motivation DNA.

On step 4: Intensity Calculation Based on Language Modifiers. The LLM uses the extracted modifier strength and tone to assign a corresponding MQ intensity (0-100) for each identified DNA.

On Step 5: MQ Profile Generation & Default Handling. The system generates a full MQ profile. Any Motivation DNA not explicitly described is set to a default intensity value of 50 and stored in the system.

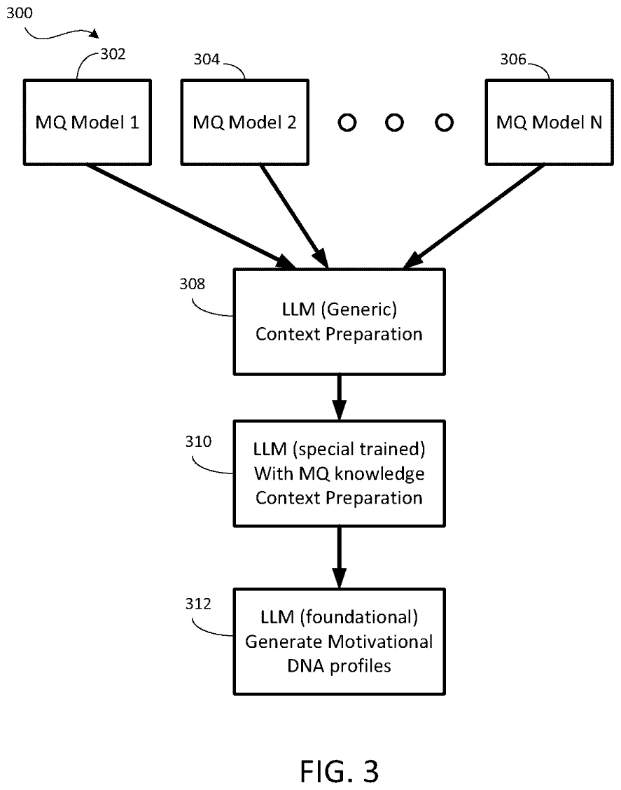

The process of the present invention can be further illustrated as follows. FIG. 3 depicts process 300, which details the preparation of specialized Motivation Quotient (MQ)-related context for use with a large language model (LLM). In this process, multiple MQ models 302, 304, 306—each containing Motivation DNA definitions, domain-specific rules, and mapping examples—are used to assemble a comprehensive MQ context. This context is first aggregated and structured within the generic LLM engine 308 and further refined in the specialized MQ context module 310. Both blocks 308 and 310 represent stages in context preparation, where information is organized, formatted, and optimized for LLM consumption. After this context preparation is completed, the resulting MQ-specific context is supplied to a generic or foundational LLM 312, enabling it to accurately interpret natural language input and generate structured Motivation DNA profiles according to the MQ system. This approach allows for flexible, domain-specific inference using the LLM, without the need for retraining its underlying model parameters.

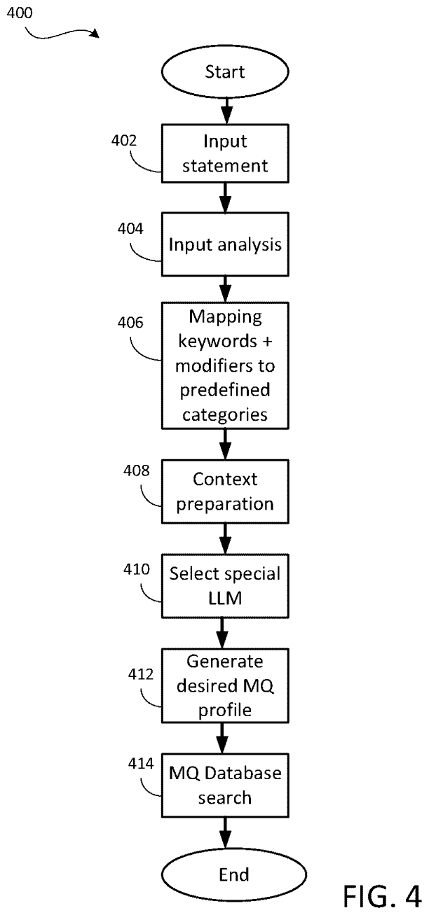

FIG. 4 illustrates process 400 for generating individualized reports or profiles for applications such as human pairing and talent recruitment. The process begins with receiving an input statement at step 402, which may describe the requirements or qualities of an individual—for example, “the candidate needs to be highly creative and detail-focused.” This statement is provided in natural language. At step 404, the statement is parsed and analyzed using a large language model (LLM), such as a Motivation DNA engine. The LLM extracts key traits and all associated modifiers from the statement, including adjectives, adverbs, and emotional tone, as described in step 406, to determine the intensity and nuance of each trait. These extracted features are considered as key words.

From these key words, the system performs context learning at step 408, in which it infers the intended purpose of the input statement (e.g., searching for a candidate for a specialized job) and prepares the relevant context for subsequent LLM processing. The intended purpose of the input statement is derived and determined when the input statement is analyzed, step 404.

At step 410, these modifiers and key words are mapped to a set of predefined categories. The prepared context is then provided to a generic or foundational LLM, which utilizes this MQ-related context to interpret and classify the input. If required, a specially configured LLM may be selected that is optimized through Retrieval-Augmented Generation (RAG) and has learned from a broad set of MQ-specific examples, including high and low score mappings.

Within this specially configured LLM, additional RAG-based examples are retrieved and referenced, ensuring that natural language patterns are accurately matched to the appropriate Motivation DNA labels. This step allows the LLM to understand how diverse descriptive phrases correspond to various Motivation DNA factors.

The LLM then utilizes the identified key words, traits, and context to assign an MQ intensity score to each detected Motivation DNA factor. The system generates a comprehensive MQ profile for the position or individual described in the original input, step 412. Any Motivation DNA factors not explicitly referenced in the input are assigned a default value, ensuring that the resulting profile is complete.

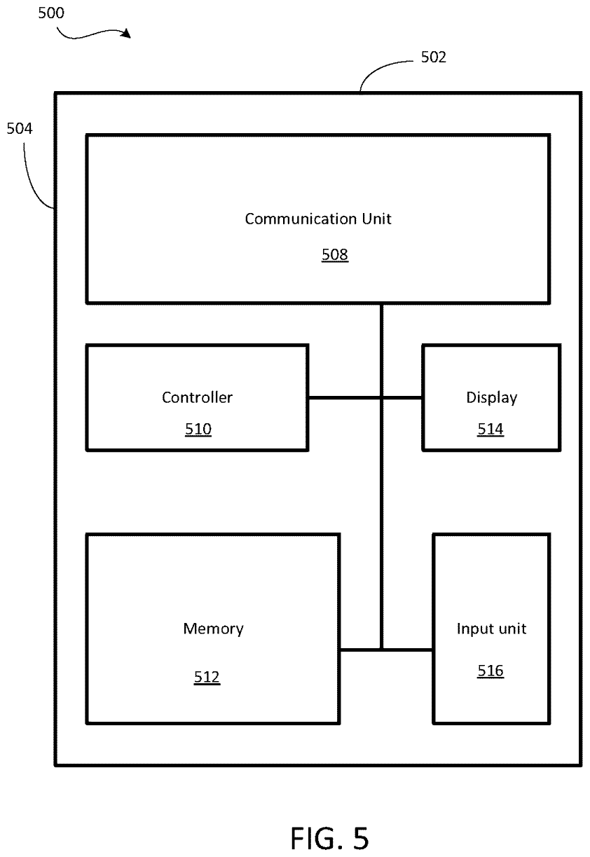

After the desired MQ profile is determined for the position, a search in the MQ database is conducted using this desired MQ profile to find the matching candidate, step 414. Prior to the present invention, the selection of the matching candidate is conducted manually by analyzing factors and strength provided by the user. FIG. 5 illustrates an exemplary architecture 500 for a Motivation DNA engine 502 of the present invention. The MQ training LLMs engine 502 has a communication unit 508 that enables the Motivation DNA engine 502 to interface with users or other servers. The Motivation DNA engine 502 further includes a controller 510, a display device 514, a memory 512, and a user interface unit 516. The display device 514 displays Motivational DNA factors and other data to the user. The user interface unit 516 enables a user to enter user inputs and/or descriptions. The memory 512 is a non-transitory memory (a computer-readable medium) and capable of storing the data and also the computer program instructions that support different features of the present invention. The controller 310 controls the operation of the Motivation DNA engine. The processes described previously by FIGS. 1-4 are performed by the Motivation DNA 502 executing the computer programs stored in the memory 512.

When in use, the system according to the present invention enables a user to use common day language to describe a set of qualities desired for a specific candidate with a set of special skills. The user can use his normal language to describe what he is looking for. The description does not have to follow any format and can be in plain language. The description is interpreted by a Motivation DNA engine. The Motivation DNA engine interprets the description by analyzing the content, the language style, and also the background of the user if available. For example, if the Motivation DNA engine has worked with the user previously, the information from the past interaction can also be used in the interpretation. The Motivation DNA engine will ultimately breaks down the description into multiple Motivational DNA factors. These Motivational DNA factors are then sent to a MQ Engine, which will generate a set of MQ data by considering all the information that is available and this MQ data is finally presented in a report to the user.

In summary, the present invention relates to an intelligent platform that integrates Large Language Models (LLM) with the Motivation DNA system to parse user input descriptions and analyze individual intrinsic motivations based on the Motivation DNA system. The system automatically converts user or third-party descriptions of specific individuals or groups into corresponding Motivation DNA factors and their intensity and then searches the Motivation DNA database for individuals who meet the specified criteria. This technology is particularly suited for applications in human pairing, talent recruitment, team formation, and personalized psychological analysis.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures and described in different embodiments can be easily combined within the scope of the invention.

1. A method for capturing a user input and generating a motivational quotient report comprising:
receiving the user input;
parsing the user input to identify key motivational factors;
selecting a special context-based large language model (LLM) engine based on the key motivational factors;
the special context-based LLM engine assigning intensity levels to the key motivational factors; and
the special context-based LLM engine generating a user profile with the key motivational factors,
wherein the special context-based LLM engine is derived from a generic LLM engine that is trained with special models with motivational factors.

2. The method of claim 1, wherein parsing the user input further comprising identifying modifiers.

3. The method of claim 2, wherein the modifiers include adjectives, adverbs, and emotional tone that influence intensity perception.

4. The method of claim 2, further comprising determining a purpose of the user input.

5. The method of claim 1, wherein the modifiers include adjectives, adverbs, and emotional tone.

6. The method of claim 1, wherein selecting a special context-based large language model (LLM) engine further comprising:
mapping the key motivational factors to a set of predefined categories; and
selecting the special context-based LLM engine based on the set of predefined categories.

7. The method of claim 1, wherein each key motivational factor has an assigned intensity level.

8. A computer-readable medium on which is stored a computer program for an web platform to use a LLM engine to generate a user profile based on a simple user input, the computer program when executed by a computer, causes the web platform to perform:
receiving the user input;
parsing the user input to identify key motivational factors;
selecting a special context-based large language model (LLM) engine based on the key motivational factors;
the special context-based LLM engine assigning intensity levels to the key motivational factors; and
the special context-based LLM engine generating a user profile with the key motivational factors,
wherein the special context-based LLM engine is derived from a generic LLM engine that is trained with special models with motivational factors.
